(19) United States
(12) Patent Application Publication
(10) Pub. No.: US 2013/0064503 A1
(43) Pub. Date: Mar. 14, 2013

(54) OPTICAL FIBER COUPLING ASSEMBLY

(71) Applicant: I-THUN LIN, Tu-Cheng (TW)

(72) Inventor: I-THUN LIN, Tu-Cheng (TW)

(73) Assignee: HON HAI PRECISION INDUSTRY CO., LTD., Tu-Cheng (TW)

(21) Appl. No.: 13/527,868

(22) Filed: Jun. 20, 2012

(30) Foreign Application Priority Data
Sep. 8, 2011 (TW) 100132365

(51) Int. Cl. G02B 6/32

(52) U.S. Cl. 385/33

(57) ABSTRACT

An optical fiber coupling assembly includes a first and a second optical fiber connectors. The first optical fiber connector includes a first light guide, a first light source, a first photoelectric conversion element, a plug holding a first optical lens, and a first optical fiber. The first optical fiber is optically aligned with the first light guide and the first optical lens. The second optical fiber connector includes a second light guide, a second light source, a second photoelectric conversion element, a second optical lens, and a second optical fiber. The second optical fiber connector defines a passage receiving the second optical lens. The second optical fiber is optically aligned with the second light guide and the second optical lens. The first and second optical lenses are aligned with each other when the plug is received in the passage.

### BACKGROUND

1. Technical Field

The present disclosure relates to optics and, particularly, to an optical fiber coupling assembly.

2. Description of Related Art

An optical fiber coupling assembly is used in data transmission between many electronic devices due to its high transmission speed and signal integrity. The optical fiber coupling assembly may include two optical fiber connectors. Each optical fiber connector includes at least two optical lenses, one for inputting optical signals and the other for outputting optical signals. When in use, the optical lenses belonging to the two optical fiber connectors must be aligned with each other. Yet, it is difficult to align the optical lenses precisely as there are at least two pairs of optical lenses. And, as the optical lenses are expensive, the cost of the optical coupling assembly is high.

Therefore, it is desirable to provide an optical fiber coupling assembly, which can overcome or at least alleviate the above-mentioned problems.

### BRIEF DESCRIPTION OF THE DRAWINGS

FIG. 1 is a schematic, isometric view of an optical fiber coupling assembly, according to an exemplary embodiment.

FIG. 2 is a sectional partial view along line II-II of the optical fiber coupling assembly of FIG. 1.

FIG. 3 is an optical pathway diagram of the optical fiber coupling assembly of FIG. 1.

### DETAILED DESCRIPTION

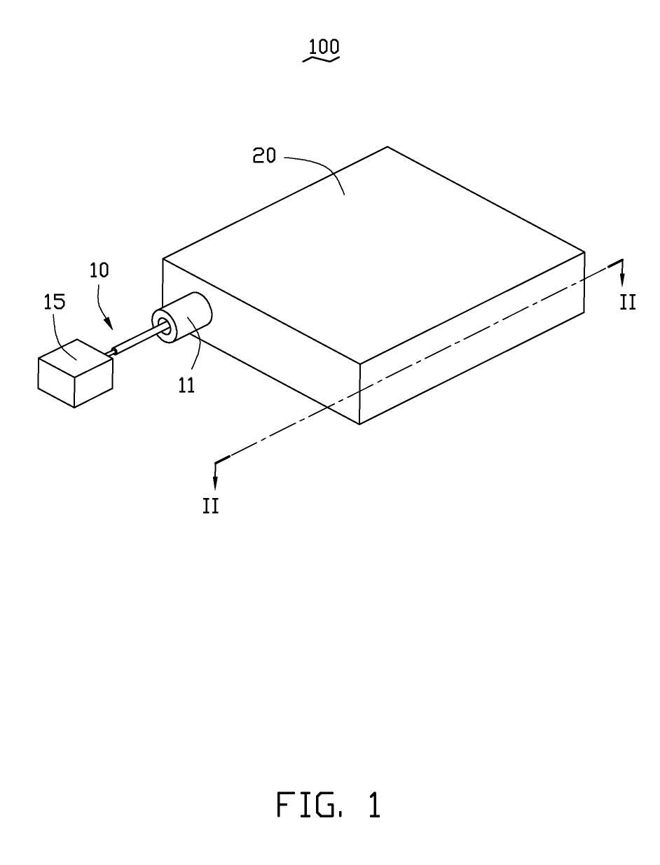

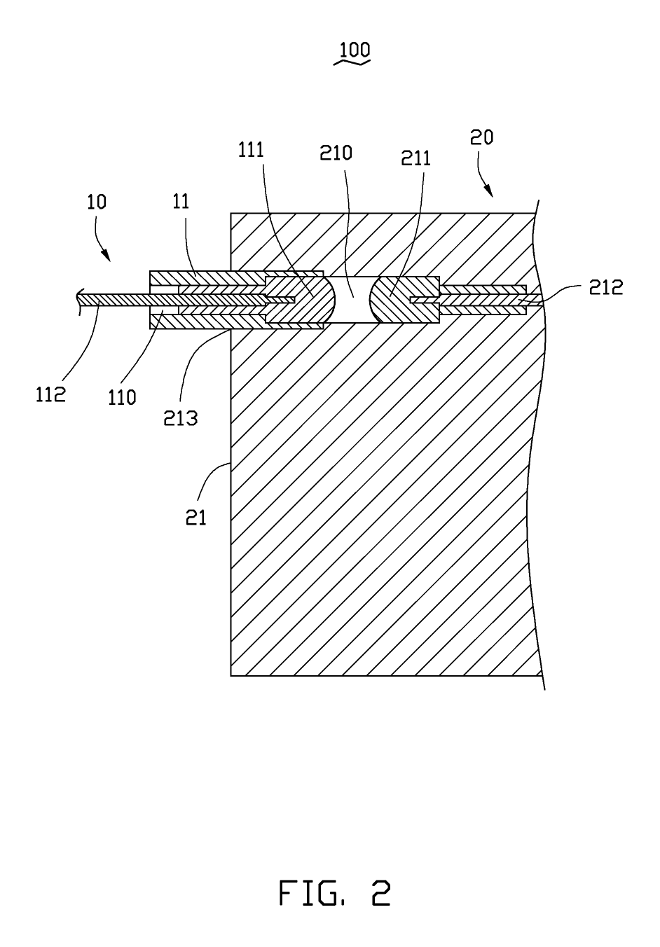

Referring to FIGS. 1 and 2, an optical fiber coupling assembly 100, according to an exemplary embodiment, includes a first optical fiber connector 10 and a second optical fiber connector 20. The first optical fiber connector 10 couples with the second optical fiber connector 20 to allow the passage of light.

The first optical fiber connector 10 includes a plug 11 and a main body 15. The plug 11 defines a first passage 110. The plug 11 includes a first optical lens 111 and a first optical fiber 112. The first optical lens 111 is mounted in the first passage 110. One end of the first optical fiber 112 extends in the first passage 110 and is connected with the first optical lens 111. The other end of the first optical fiber 112 extends out of the first passage 110 and is connected with the main body 15.

The second optical fiber connector 20 defines a second passage 210. The second optical fiber connector 20 includes a second optical lens 211 and a second optical fiber 212. The second optical lens 211 is mounted in the second passage 210. The second optical fiber 212 extends in the second passage 210 and is connected with the second optical lens 211 at one end. The second passage 210 includes an opening 213 defined at a side surface 21 of the second optical fiber connector 20. The plug 11 can be inserted into the second passage 210 through the opening 213 to align the first and second optical lenses 111, 211.

In this embodiment, the first and second optical lenses 111, 211 are both convex. For enhancing the focusing efficiency, one end of the first optical fiber 112 is positioned at the focus surface of the first optical lens 111, and one end of the second optical fiber 212 is positioned at the focus surface of the second optical lens 211.

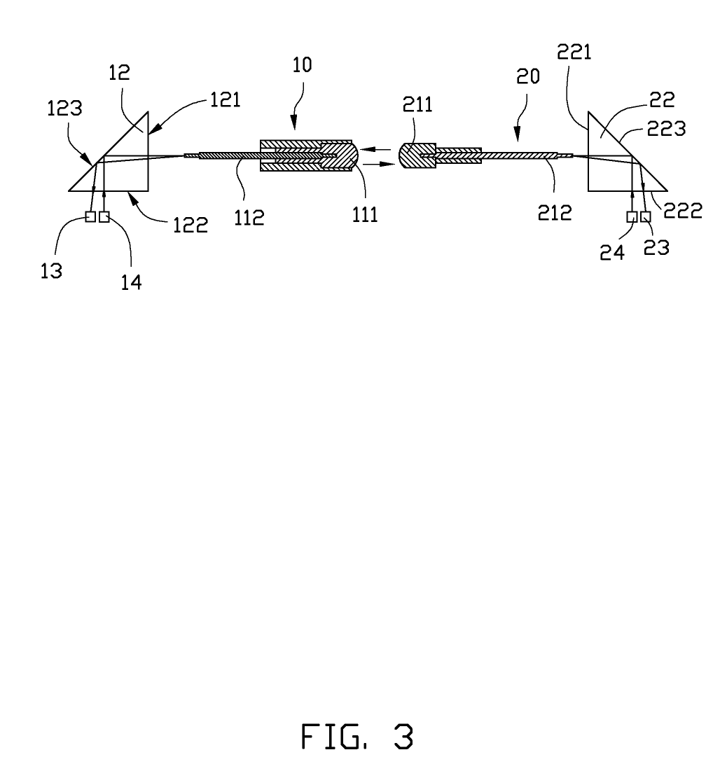

Referring also to FIG. 3, the first optical fiber connector 10 further includes a first light guide 12, a first light source 13, and a first photoelectric conversion element 14. The first light guide 12, the first light source 13, and the first photoelectric conversion element 14 are all mounted in the main body 15. The second optical fiber connector 20 further includes a second light guide 22, a second light source 23, and a second photoelectric conversion element 24. The first and second light sources 13, 23 are laser diodes. A first optical signal emitted by the first light source 13 and a second optical signal emitted by the second light source 23 have different wavelengths. In this embodiment, the wavelength of the first optical signal is about 1310 nanometers (nm), and the wavelength of the second optical signal is about 1550 nm. The first and second photoelectric conversion elements 14, 24 are photodiodes and are used to convert the first and second optical signals into first and second electrical signals.

The first and second light guides 12, 22 are spectroscopes. In this embodiment, the first and second light guides 12, 22 are triangular prisms.

The first light guide 12 includes a first surface 121 adjacent to the first optical fiber 112, a second surface 122 adjacent to the first light source 13 and the first photoelectric conversion element 14, and a third surface 123 connected between the first surface 121 and the second surface 122. The first surface 121 is substantially perpendicular to the second surface 122. An included angle between the second surface 122 and the third surface 123 is about 45 degrees. In this embodiment, the third surface 123 is a reflective surface.

The second light guide 22 includes a fourth surface 221 adjacent to the second optical fiber 212, a fifth surface 222 adjacent to the second light source 23 and the second photoelectric conversion element 24, and a sixth surface 223 connected between the fourth surface 221 and the fifth surface 222. An included angle between the fifth surface 222 and the sixth surface 223 is about 45 degrees. In this embodiment, the sixth surface 223 is a reflective surface.

The first optical signal emitted by the first light source 13 is perpendicular to the second surface 122, thus when the first optical signal enters the first light guide 12 from the second surface 122, refraction will not occur. The first optical signal is reflected by the third surface 123 and is directed to the first optical fiber 112. Then the first optical signal is transmitted by the first optical fiber 112, the first optical lens 111, the second optical lens 211, and the second optical fiber 212, and is then directed to the forth surface 221 of the second light guide 22.

The second optical signal emitted by the second light source 23 is perpendicular to the fifth surface 222. The second optical signal is directed to the first surface 121 of the first light guide 12 in a sequence which is reversed relative to the first optical signal. As the first and second optical signals have different wavelengths, the first and second optical signals can be transmitted at the same time and will not interfere with each other.

Although the second optical fiber 212 is perpendicular to the fourth surface 221, the transmitting direction of the first optical signal is not perpendicular to the fourth surface 221. When the first optical signal enters the second light guide 22 from the fourth surface 221, refraction occurs and makes the light path of the first optical signal deviate from the light path of the second optical signal. Then the first optical signal is reflected by the sixth surface 223 and is directed to the second photoelectric conversion element 24 positioned beside the second light source 23 and is converted into the first electrical signal. Similarly, the second optical signal is directed to the first photoelectric conversion element 14 positioned beside the first light source 13 and is converted into the second electrical signal.

The present disclosure uses only one pair of lens to transmit bidirectional optical signals, thus the cost of the optical fiber coupling assembly 100 is significantly reduced.

Even though numerous characteristics and advantages of the present embodiments have been set fourth in the foregoing description, together with details of the structures and functions of the embodiments, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. An optical fiber coupling assembly, comprising:
a first optical fiber connector comprising:
a main body comprising a first light guide, a first light source, and a first photoelectric conversion element;
a plug comprising a first optical lens; and
a first optical fiber optically aligned with the first light guide and the first optical lens; and
a second optical fiber connector defining a first passage capable of receiving the plug, the second optical fiber connector comprising:
a second optical lens received in the first passage and capable of coupling with the first optical lens when the plug is inserted in the first passage;
a second light guide;
a second optical fiber optically aligned with the second light guide and the second optical lens;
a second light source; and
a second photoelectric conversion element; wherein
when the first light source emits a first light signal having a first wavelength, the first light signal is transmitted by the first light guide, the first optical fiber, the first optical lens, the second optical lens, the second optical fiber, and the second light guide in sequence and is finally directed to the second photoelectric conversion element;
when the second light source emits a second light signal having a second wavelength, the second light signal is transmitted by the second light guide, the second optical fiber, the second optical lens, the first optical lens, the first optical fiber, and the first light guide in sequence and is finally directed to the first photoelectric conversion element; and
the first wavelength is different from the second wavelength.

2. The optical fiber coupling assembly of claim 1, wherein the first light guide and the second light guide are spectroscopes.

3. The optical fiber coupling assembly of claim 2, wherein the first light guide and the second light guide are triangular prisms.

4. The optical fiber coupling assembly of claim 3, wherein the first light guide comprises a first surface adjacent to the first optical fiber, a second surface adjacent to the first light source and the first photoelectric element, and a third surface connecting the first surface to the second surface; and the second light guide comprises a forth surface adjacent to the second optical fiber, a fifth surface adjacent to the second light source and the second photoelectric element, and a sixth surface connecting the forth source to the fifth surface.

5. The optical fiber coupling assembly of claim 4, wherein the third surface and the sixth surface are reflective surfaces.

6. The optical fiber coupling assembly of claim 1, wherein the first light source and the second light source are laser diodes.

7. The optical fiber coupling assembly of claim 1, wherein the first photoelectric element and the second photoelectric element are photodiodes.

8. The optical fiber coupling assembly of claim 1, wherein the plug defines a second passage; the first optical lens is mounted in the second passage; one end of the first optical fiber extends in the second passage and is connected with the first optical lens, and the other end of the first optical fiber extends out of the second passage and is aligned with the first light guide.

9. The optical fiber coupling assembly of claim 8, wherein one end of the second optical fiber extends in the first passage and is connected with the second optical lens, and the other end of the second optical fiber is aligned with the second light guide.

10. The optical fiber coupling assembly of claim 9, wherein the end of the first optical fiber connected with the first optical lens is positioned at a focus surface of the first optical lens; the end of the second optical fiber connected with the second optical lens is positioned at a focus surface of the second optical lens.
